(19) United States
(12) Patent Application Publication
(10) Pub. No.: US 2021/0152332 A1
(43) Pub. Date: May 20, 2021

(54) APPARATUS FOR ADDING DATA TO BLOCKCHAIN, DATA VERIFICATION APPARATUS, AND DATA VERIFICATION METHOD

(71) Applicant: Institute For Information Industry, Taipei (TW)

(72) Inventor: Po-Chih CHEN, Taipei (TW)

(21) Appl. No.: 16/706,569

(22) Filed: Dec. 6, 2019

(30) Foreign Application Priority Data
Nov. 14, 2019 (TW) 108141397

(51) Int. Cl. H04L 9/06; H04L 9/32; H04L 9/30; G06F 16/23

(52) U.S. Cl. CPC H04L 9/0637; H04L 9/3239; G06Q 50/04; G06F 16/2315; H04L 9/3066

(57) ABSTRACT

An apparatus for adding data to blockchain, a data verification apparatus, and a data verification method are provided. The apparatus includes a microcontroller and a transmission interface, wherein the transmission I'nterface is electrically connected to the microcontroller. The microcontroller generates a hash data for an original data of a device according to an algorithm, wherein the hash data is readable by a blockchain. The transmission interface transmits the original data and the hash data to a blockchain agent platform. The transmission interface also receives a slice of a Merkle tree regarding a node that the hash data is located from the blockchain agent platform. The slice includes an evidence data generated based on the hash data.

### PRIORITY

This application claims priority to Taiwan Patent Application No. 108141397 filed on Nov. 14, 2019, which is hereby incorporated by reference in its entirety.

### FIELD

The present invention relates to an apparatus for adding data to blockchain, a data verification apparatus, and a data verification method. In particular, the present invention relates to an apparatus for adding data to blockchain, a data verification apparatus, and a data verification method for the Internet of Things (IoT).

### BACKGROUND

With the rapid development of the science and technology and economy, operations of many industries involve the IoT. Through the IoT, data of various devices and apparatuses is transmitted to remote devices for storage and analysis in order to be used for subsequent applications, e.g., for verifying the correctness of device data in the IoT. For example, manufacturers often construct the IoT to collect environmental factors (e.g., temperature, pressure, humidity, etc.) of production lines when manufacturing products, and the data corresponding to these environmental factors needs to be recorded for auditing and/or verification. As another example, some operators put second-hand devices (e.g. industrial batteries, industrial motors, automobiles) into the trading market. However, no mechanism is currently available for preventing the data of the second-hand devices (e.g. charging and discharging times of industrial batteries, mileage of automobiles) from being altered, which results in many disputes. Therefore, there is a strong need for a data transmission and verification mechanism.

Accordingly, there is an urgent need for a technique that can encrypt and store data of the devices in the IoT and let a credible platform query and verify the data in order to ensure the credibility of the data.

### SUMMARY

To solve the aforesaid technical problems, provided are an apparatus for adding data to blockchain, a data verification apparatus, and a data verification method.

The apparatus for adding data to blockchain in one example may comprise a microcontroller and a transmission interface, wherein the transmission interface is electrically connected to the microcontroller. The microcontroller generates a hash data for an original data of a device according to an algorithm, wherein the hash data is readable by a blockchain. The transmission interface transmits the original data and the hash data to a blockchain agent platform. The transmission interface further receives a slice of a Merkle tree regarding a node that the hash data is located from the blockchain agent platform, wherein the slice comprises a first evidence data generated based on the hash data.

The apparatus for adding data to blockchain may also comprise a storage electrically connected to the processor, and the storage stores an identification code of the microcontroller. The transmission interface further transmits the identification code and a time stamp corresponding to the original data to a blockchain node of a public blockchain. The transmission interface further receives a second evidence data retrieved based on the identification code and the time stamp from a smart contract of the blockchain node. The microcontroller further retrieves the first evidence data from the slice, and determines a result of adding the hash data to the smart contract by comparing the first evidence data with the second evidence data.

The data verification apparatus in certain examples may comprise a storage, a transmission interface, and a processor, wherein the processor is electrically connected to the storage and the transmission interface. The storage stores a hash chain record, and the hash chain record comprises a plurality of evidence slices. The transmission interface transmits an identification code of a microcontroller and a time stamp to a blockchain agent platform and receives a first evidence data as well as an original data and a slice of a Merkel tree retrieved based on the identification code and the time stamp from the blockchain agent platform. The transmission interface further receives a second evidence data from a smart contract of a blockchain node of a public blockchain. The processor determines a first verification result by comparing the first evidence data and the second evidence data. When the first verification result is that the first evidence data is consistent with the second evidence data, the processor further generates a hash data for the original data, generates a third evidence data according to the hash data and the slice, generates a fourth evidence data according to the third evidence data and at least one of the evidence slices, and determines a second verification result by comparing the first evidence data with the fourth evidence data. The data verification method is adapted for use in an electronic computing apparatus.

The electronic computing apparatus stores a hash chain record, and the hash chain record comprises a plurality of evidence slices. The data verification method in certain examples may comprise: (a) transmitting an identification code of a microcontroller and a time stamp to a blockchain agent platform, (b) receiving a first evidence data as well as an original data and a slice of a Merkel tree retrieved based on the identification code and the time stamp from the blockchain agent platform, (c) receiving a second evidence data from a smart contract of a blockchain node of a public blockchain, (d) determining that the first evidence data is consistent with the second evidence data, (e) generating a hash data for the original data, (f) generating a third evidence data according to the hash data and the slice, (g) generating a fourth evidence data according to the third evidence data and at least one of the evidence slices, and (h) determining a verification result by comparing the first evidence data with the fourth evidence data.

According to the above descriptions, the apparatus for adding data to blockchain corresponds to a device and utilizes the blockchain agent platform to add the hash data corresponding to the device to a blockchain. With the above configuration, the technical problem that the prior art cannot add a large amount of device data of the IoT to a blockchain is solved. In addition, the data verification apparatus stores a hash chain record identical to that in the public blockchain. Whenever a user wants to query and/or verify the original data of a certain device at a certain time, the data verification apparatus does not need to download a large amount of data from the public blockchain to perform verification. The data verification apparatus can complete data verification by simply downloading the latest evidence data from a smart contract of a blockchain node of the public blockchain. Therefore, the data verification apparatus will not occupy the bandwidth of the public blockchain when verifying and/or querying data.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a data verification system DS of a first embodiment;

FIG. 1B is a schematic view of the architecture of and the operations performed by an apparatus 1a for adding data to blockchain;

FIG. 1C is a specific example of a Merkel tree;

FIG. 1D is a schematic view of the architecture of and the operation performed by a data verification apparatus 2;

FIG. 1E is a schematic view of generating an evidence data R10′ according to a hash data HD′ and a slice S10; and

FIG. 2 is a flowchart of a data verification method of a second embodiment.

### DETAILED DESCRIPTION

In the following description, the apparatus for adding data to blockchain, the data verification apparatus, and the data verification method provided in the present invention will be explained with reference to certain example embodiments thereof. However, these example embodiments are not intended to limit the present invention to any specific environment, example, embodiment, applications, or implementations described in these example embodiments. Therefore, description of these example embodiments is only for the purpose of illustration rather than to limit the scope of the present invention.

It should be appreciated that, in the following embodiments and the attached drawings, elements unrelated to the present invention are omitted from depiction, Furthermore, dimensions of elements and dimensional scales between individual elements in the attached drawings are provided only for ease of depiction and illustration, but not to limit the scope of the present invention.

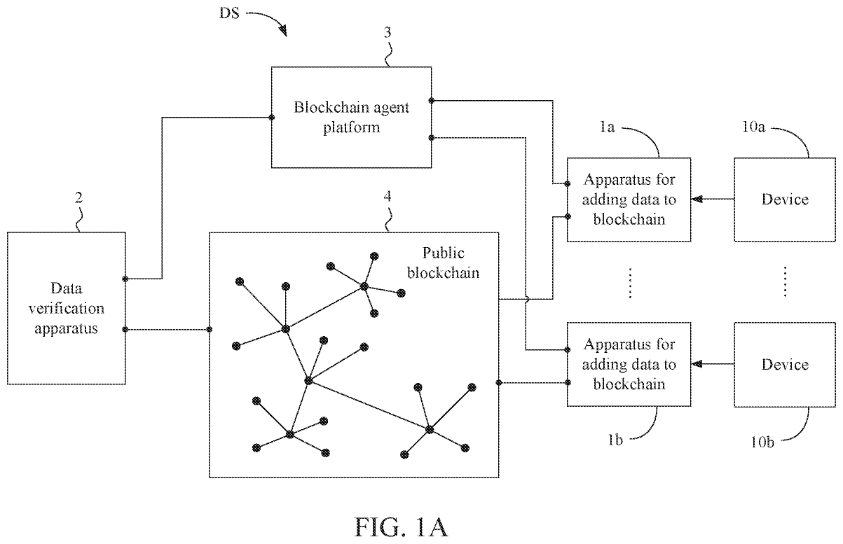

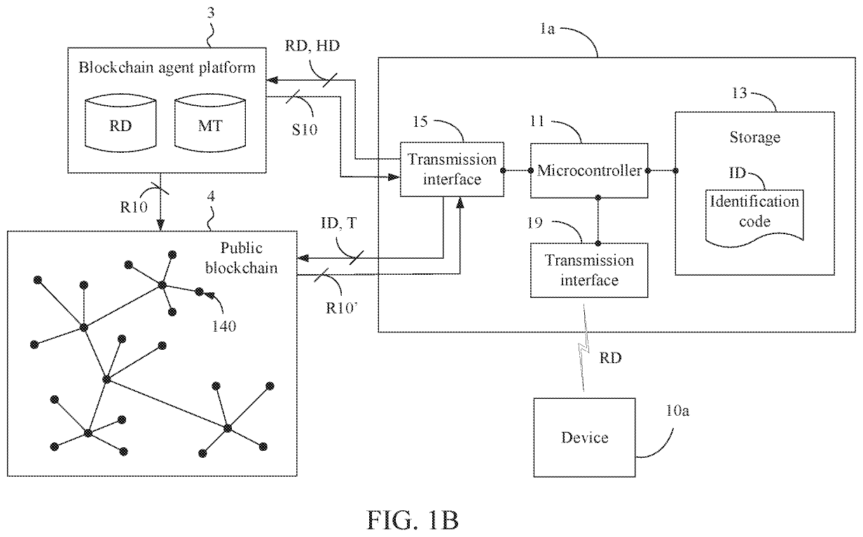

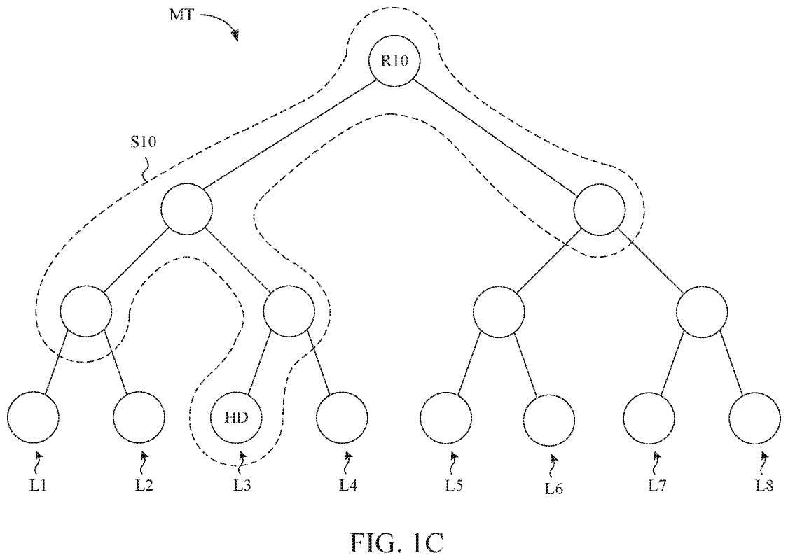

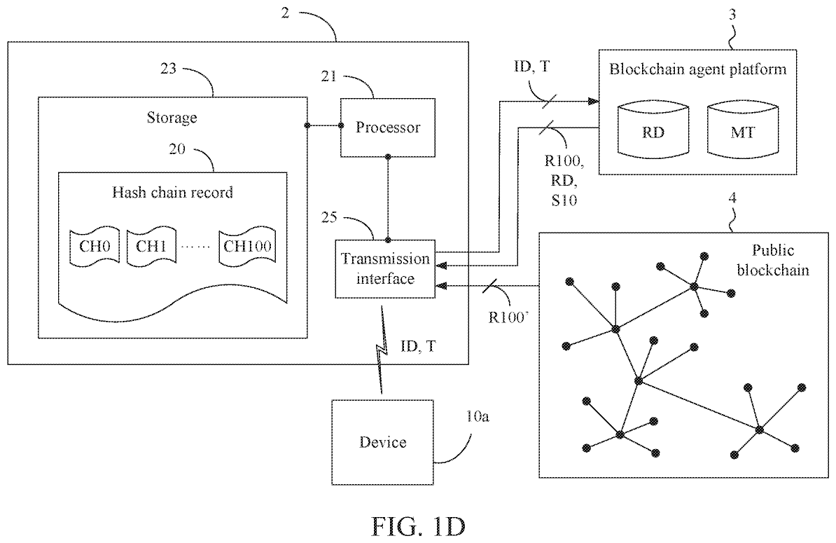

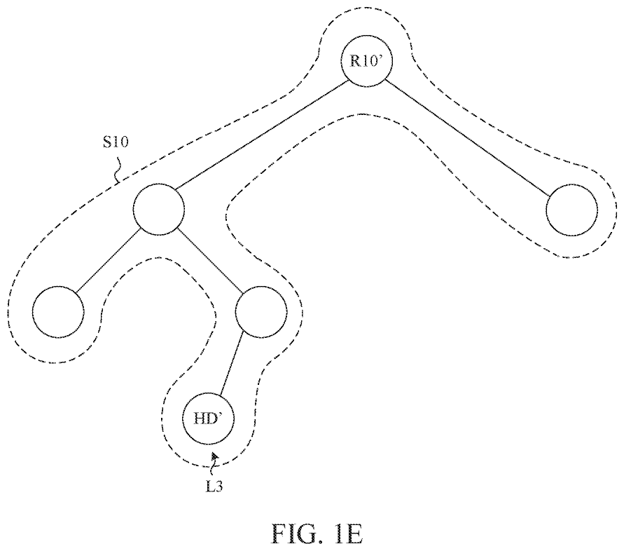

A first embodiment of the present invention is a data verification system DS, whose schematic view is depicted in FIG. 1A. The data verification system DS comprises a plurality of apparatuses 1a, . . . , 1b for adding data to blockchain, a data verification apparatus 2, a blockchain agent platform 3, and a public blockchain 4. The apparatuses 1a, . . . , 1b for adding data to blockchain correspond to devices 10a, . . . , 10b one-to-one. For example, if the data verification system DS is applied to a manufacturing factory, each sensor in each production line of the manufacturing factory may be provided with a corresponding apparatus for adding data to blockchain. As another example, if the data verification system DS is applied to the second-hand trading market, each second-hand device will have a corresponding apparatus for adding data to blockchain. In FIG. 1A, each black dot in the public blockchain 4 represents a blockchain node.

The operations performed by the data verification system DS may be divided into two aspects, wherein one aspect is adding data to blockchain and the other aspect is data verification. First, the operations related to adding data to blockchain in the data verification system DS will be described. Since the apparatuses 1a, . . . , 1b for adding data to blockchain adopt similar operations to request the blockchain agent platform 3 to assist in adding data to blockchain, the following descriptions will focus on the apparatus 1a for adding data to blockchain as an example.

Please refer to FIG. 1B, which is a schematic view depicting the architecture of and the operation performed by the apparatus 1a for adding data to blockchain. The apparatus 1a for adding data to blockchain comprises a microcontroller (MCU) 11, a transmission interface 15, and a transmission interface 19, wherein the transmission interface 15 and the transmission interface 19 are electrically connected to the microcontroller 11. The microcontroller 11 may be one of various single-chip microcontrollers or other single-chip microcomputers known to a person having ordinary skill in the art. The transmission interface 15 may be any interface capable of communicating with apparatuses in a network, e.g., a Bluetooth interface and a Wi-Fi interface, without being limited thereto. The transmission interface 19 may be any interface that may be used in combination with the microcontroller 11 and capable of transmitting signals, e.g., a serial communication interface (SCI), a universal asynchronous receiver/transmitter (UART), without being limited thereto.

In this embodiment, the apparatus 1a for adding data to blockchain is used with the device 10a (e.g., a temperature sensor on a production line). The transmission interface 19 receives an original data RD from the device 10a periodically or non-periodically. The values of the original data RD received at different time points may be the same or different. In other embodiments, the apparatus 1a for adding data to blockchain and the corresponding device may be integrated in the same apparatus and, thus, the transmission interface 19 for receiving the original data RD from the outside may be omitted.

In this embodiment, the microcontroller 11 of the apparatus 1a for adding data to blockchain generates a hash data HD for the original data RD of the device 10a according to an algorithm, wherein the hash data HD is readable by the blockchain. For example, the microcontroller 11 may adopt an algorithm to encrypt the original data RD and a time stamp T corresponding to the original data RD into the hash data HD. The aforementioned algorithm may be an encryption algorithm, e.g., one of an Advanced Encryption Standard (AES) algorithm, a Secure Hash Algorithm (SHA), an Elliptic Curve Cryptography (ECC) algorithm and a Base algorithm, without being limited thereto. It is noted that a person having ordinary skill in the art shall appreciate how to encrypt the original data RD and the corresponding time stamp T into the hash data HD by an algorithm, so the details will not be described herein.

Thereafter, the transmission interface 15 of the apparatus 1a for adding data to blockchain transmits the original data RD and the hash data HD to the blockchain agent platform 3. In this embodiment, the blockchain agent platform 3 may be implemented by Amazon Managed Blockchain provided by Amazon.com, Inc., may be implemented by a blockchain trust technology developed by International Trust Machines Corporation (ITM), or may be implemented by Azure Blockchain Workbench developed by Microsoft Corporation, without being limited thereto.

The blockchain agent platform 3 receives the original data RD and the hash data HD transmitted from the apparatus 1a for adding data to blockchain and stores the original data RD. In addition, for the hash data HD, the blockchain agent platform 3 establishes a Merkle Tree MT after the number of the hash data received from the apparatuses 1a, . . . , 1b for adding data to blockchain reaches the power-of-two. The data stored in the root node of the Merkel tree MT is an evidence data R10 generated by the blockchain agent platform 3 based on the hash data HD corresponding to the original data RD.

For comprehension, please refer to a specific example of the Merkel tree MT shown in FIG. 1C, but this specific example is not intended to limit the scope of the present invention. In this specific example, the Merkel tree MT contains eight leaf nodes L1 to L8, and each of the leaf nodes L1 to L8 stores a hash data from any of the apparatuses 1a, . . . , 1b for adding data to blockchain, wherein the leaf node L3 stores the hash data HD described above. The blockchain agent platform 3 establishes the Merkel tree MT after the number of the collected hash data reaches the power-of-two. Please noted that a person having ordinary skill in the art shall understand how the blockchain agent platform 3 establishes a Merkel tree according to a plurality of hash data whose amount is power-of-two and, thus, the details will not be further described herein.

The blockchain agent platform 3 stores the Merkel tree MT. The blockchain agent platform 3 transmits the evidence data R10 corresponding to the Merkel tree MT (i.e., the data stored in the root node of the Merkel tree MT) to the public blockchain 4 so that the smart contract of each blockchain node (including the blockchain node 140) in the public blockchain 4 stores the evidence data R10. In addition, the blockchain agent platform 3 transmits a slice S10 of the Merkle tree MT regarding a node that the hash data HD is located to the apparatus 1a for adding data to blockchain, and the apparatus 1a for adding data to blockchain receives the slice S10 by the transmission interface 15. The slice S10 comprises the evidence data R10 generated based on the hash data HD as shown in FIG. 1C.

With the above operations, the apparatus 1a for adding data to blockchain completes the task of adding the hash data HD corresponding to the original data RD to the blockchain via the blockchain agent platform 3.

It is noted that the blockchain agent platform 3 continuously receives the original data and the hash data transmitted from the apparatuses 1a, . . . , 1b for adding data to blockchain. The blockchain agent platform 3 stores these original data. In addition, whenever the number of the hash data collected by the blockchain agent platform 3 reaches the power-of-two, the blockchain agent platform 3 establishes a Merkel tree and then store it. In this way, the blockchain agent platform 3 will store multiple Merkel trees. The blockchain agent platform 3 further transmits the evidence data corresponding to each Merkel tree (i.e., the data stored in the root node) to the public blockchain 4. The smart contract of each blockchain node in the public blockchain 4 stores these evidence data in the form of a blockchain (which will be described later).

In some embodiments, the apparatus 1a for adding data to blockchain may further confirm whether the hash data HD corresponding to the original data RD has been correctly added to the blockchain. For those embodiments, the apparatus 1a for adding data to blockchain further comprises a storage 13, and the storage 13 is electrically connected to the microcontroller 11. The storage 13 may be a memory, e.g., a read-only memory (ROM), a random access memory (RAM), without being limited thereto. The storage 13 stores an identification code ID of the microcontroller 11.

The transmission interface 15 transmits the identification code ID and the time stamp T corresponding to the original data RD to a blockchain node 140 of the public blockchain 4. The blockchain node 140 retrieves an evidence data R10′ from the smart contract according to the identification code ID and the time stamp T. Next, the transmission interface 15 receives the evidence data R10′ retrieved based on the identification code ID and the time stamp T from the blockchain node 140.

The microcontroller 11 of the apparatus 1a for adding data to blockchain retrieves the evidence data R10 from the slice S10. The microcontroller 11 determines a result of adding the hash data HD to the smart contract by comparing the evidence data R10 retrieved from the slice S10 with the evidence data R10′ received from the blockchain node 140. If the microcontroller 11 determines that the evidence data R10 is the same as the evidence data R10′, it means that the result is that the hash data HD has been correctly added to the smart contract. If the microcontroller 11 determines that the evidence data R10 is different from the evidence data R10′, it means that the result is that the hash data HD has not been correctly added to the smart contract. Thereby, the apparatus 1a for adding data to blockchain can confirm whether the blockchain agent platform 3 has correctly added the hash data HD corresponding to the original data RD to blockchain.

Next, the operations related to data verification in the data verification system DS will be described. Please refer to FIG. 1D, which is a schematic view depicting the architecture of and the operation performed by the data verification apparatus 2. The data verification apparatus 2 comprises a processor 21, a storage 23, and a transmission interface 25, wherein the processor 21 is electrically connected to the storage 23 and the transmission interface 25. The processor 21 may be one of various processors, central processing units (CPUs), microprocessors, or other computing devices well-known to a person having ordinary skill in the art. The storage 23 may be a memory, a hard disk drive (HDD), a universal serial bus (USB), a compact disk (CD), or any other non-transitory storage medium or devices capable of storing digital data and well-known to a person having ordinary skill in the art. The transmission interface 25 may be any wired interface or wireless interface capable of communicating with devices in a network.

The storage 23 stores a hash chain record 20, and the hash chain record 20 comprises a plurality of evidence slices CH0, CH1, . . . , CH100. Each of the evidence slices CH0, CH1, . . . , CH100 is a block in the blockchain, wherein each block comprises a block header and a block body, and each block body stores an evidence data generated by the blockchain agent platform 3. The evidence slices CH0, CH1, . . . , CH100 are arranged sequentially as a chain, wherein the evidence slice CH100 is the latest evidence slice. Each blockchain node in the public blockchain 4 stores the same hash chain record 20. The architecture of the blockchain shall be well-known to a person having ordinary skill in the art, so will not be further described herein.

Hereby, it is assumed that a user wants to inquire the original data of the device 10a at a certain time (corresponding to the time stamp T). The owner of the device 10a provides the identification code ID and time stamp T stored by the apparatus 1a for adding data to blockchain corresponding to the device 10a to the user for the user to query by the data verification apparatus 2.

The user inputs the identification code ID and the time stamp T into the data verification apparatus 2. The data verification apparatus 2 transmits the identification code ID and the time stamp T to the blockchain agent platform 3 via the transmission interface 25. The transmission interface 25 receives the latest evidence data R100 as well as the original data RD and the slice S10 of the Merkel tree MT retrieved based on the identification code ID and the time stamp T from the blockchain agent platform 3. Additionally, the transmission interface 25 receives the latest evidence data R100′ from the smart contract of a blockchain node of the public blockchain 4.

Next, the processor 21 of the data verification apparatus 2 determines a first verification result by comparing the latest evidence data R100 received from the blockchain agent platform 3 with the latest evidence data R100′ received from the smart contract of the blockchain node of the public blockchain 4. Then, the data verification apparatus 2 determines whether to continue the subsequent verification based on the first verification result. If the first verification result is that the evidence data R100 is inconsistent with the evidence data R100′, the processor 21 will not perform the subsequent verification.

If the first verification result is that the evidence data R100 is consistent with the evidence data R100′, the processor 21 will perform subsequent verification. Specifically, the processor 21 generates a hash data HD′ for the original data RD according to the same algorithm and then generates an evidence data R10′ according to the hash data HD′ and the slice S10 (i.e., input the hash data HD′ into the node corresponding to the leaf node L3 in the slice S10 and infer the data of the root node from other nodes as the evidence data R10′ as shown in FIG. 1E). Next, the processor 21 generates another latest evidence data (not shown) according to the evidence data R10′ and at least one of the evidence slices in the hash chain record 20 (i.e., from the evidence slice that comprises the evidence data R10′ to the latest evidence slice CH100). Thereafter, the processor 21 determines a second verification result by comparing the evidence data R100 (or the evidence data R100′) with the latest evidence data generated by the processor 21. If the second verification result is that the evidence data R100 (or the evidence data R100′) is the same as the latest evidence data generated by the processor 21, it means that the original data RD transmitted from the blockchain agent platform 3 is correct. If the second verification result is that the evidence data R100 (or the evidence data R100′) is different from the latest evidence data generated by the processor 21, it means that the original data RD transmitted from the blockchain agent platform 3 is erroneous.

According to the above description, in the data verification system DS, the apparatuses 1a, . . . , 1b for adding data to blockchain correspond to devices 10a, . . . , 10b one-to-one. Each of the apparatuses 1a, . . . , 1b for adding data to blockchain may utilize the blockchain agent platform 3 to add the hash data corresponding to the device to a blockchain. With the above configuration, the technical problem that the prior art cannot add a large amount of device data in the IoT to blockchain is solved. In addition, the data verification apparatus 2 in the data verification system DS stores a hash chain record 20 identical to that in the public blockchain 4. Whenever a user wants to query and/or verify the original data of a certain device at a certain time, the data verification apparatus 2 does not need to download a large amount of data from the public blockchain 4 to perform verification. The data verification apparatus 2 can complete data verification by simply downloading the latest evidence data from a smart contract of a blockchain node of the public blockchain. Therefore, the data verification apparatus 2 will not occupy the bandwidth of the public blockchain 4 when verifying and/or querying data.

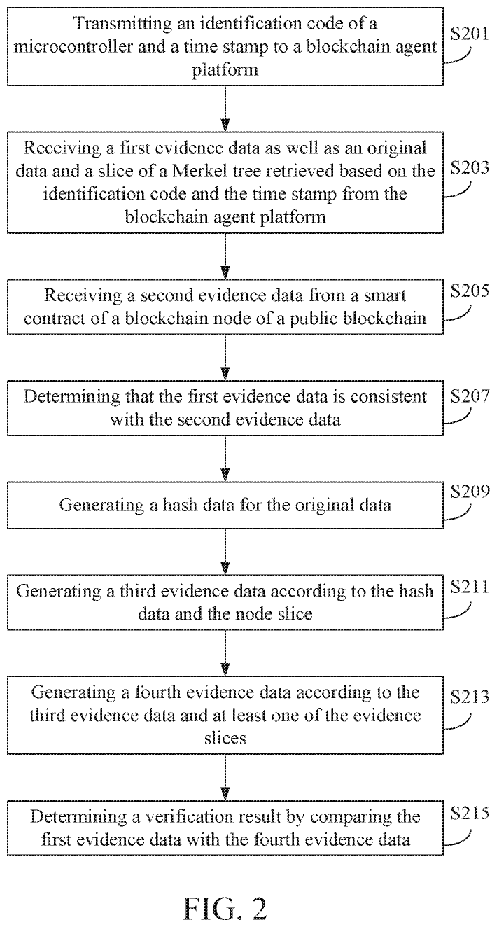

A second embodiment of the present invention is a data verification method, and a main flowchart thereof is depicted in FIG. 2. The data verification method is adapted for use in an electronic computing apparatus (e.g., the data verification apparatus 2 in the first embodiment). The electronic computing apparatus stores a hash chain record, wherein the hash chain record comprises a plurality of evidence slices. The data verification method comprises steps S201 to S215.

Specifically, in the step S201, the electronic computing apparatus transmits an identification code of a microcontroller and a time stamp to a blockchain agent platform. In the step S203, the electronic computing apparatus receives a first evidence data as well as an original data and a slice of a Merkel tree retrieved based on the identification code and the time stamp from the blockchain agent platform. Next, in the step S205, the electronic computing apparatus receives a second evidence data from a smart contract of a blockchain node of a public blockchain.

In this embodiment, the data verification method determines that the first evidence data is consistent with the second evidence data by the electronic computing apparatus in the step S207. Please noted that if the verification result is that the first evidence data is inconsistent with the second evidence data, the data verification method will not perform the subsequent verification steps. In this embodiment, it is determined that the first evidence data is consistent with the second evidence data in the step S207, so the data verification method performs the subsequent verification steps.

In the step S209, the electronic computing apparatus generates a hash data for the original data. In some embodiments, the step S209 encrypts the original data and the time stamp into the hash data by the electronic computing apparatus by adopting an algorithm. The algorithm may be an encryption algorithm, e.g., an AES algorithm, a SHA, an ECC algorithm, and a Base algorithm, without being limited thereto.

Additionally, in the step S211, the electronic computing apparatus generates a third evidence data according to the hash data and the slice. Next, in the step S213, the electronic computing apparatus generates a fourth evidence data according to the third evidence data and at least one of the evidence slices. Then, in the step S215, the electronic computing apparatus determines a verification result by comparing the first evidence data with the fourth evidence data.

If the verification result determined in the step S215 is that the first evidence data (or the second evidence data) is the same as the fourth evidence data, it means that the original data transmitted from the blockchain agent platform is correct. If the verification result determined in the step S215 is that the first evidence data (or the second evidence data) is different from the fourth evidence data, it means that the original data transmitted from the blockchain agent platform is erroneous.

In addition to the aforesaid steps, the second embodiment can also execute all the operations and steps of the data verification apparatus 2 set forth in the first embodiment, have the same functions, and deliver the same technical effects as the first embodiment. How the second embodiment executes these operations and steps, have the same functions, and deliver the same technical effects as the first embodiment will be readily appreciated by those of ordinary skill in the art based on the explanation of the first embodiment, so the details are not given herein.

It is noted that in the specification and claims of this application, some words (including transmission interface, evidence data, verification result, etc.) are preceded by ordinal numerals “first,” “second,” “third,” or “fourth” and these ordinal numerals are only used to distinguish that these words refer to different items.

According to the above descriptions, the apparatus for adding data to blockchain and the data verification apparatus provided by the present invention may be used in combination with the blockchain agent platform and the public blockchain to form a data verification system. In the data verification system, a plurality of apparatuses for adding data to blockchain correspond to a plurality of devices in the IoT in one-to-one, and each of the apparatuses for adding data to blockchain utilizes the blockchain agent platform to add the hash data of the corresponding device to a blockchain. With the above configuration, the technical problem that the prior art cannot add a large amount of device data of the IoT to a blockchain is solved. In addition, the data verification apparatus in the data verification system stores a hash chain record identical to that in the public blockchain. Whenever a user wants to query and/or verify the original data of a certain device at a certain time, the data verification apparatus does not need to download a large amount of data from the public blockchain to perform verification. The data verification apparatus can complete data verification by simply downloading the latest evidence data from a smart contract of a blockchain node of the public blockchain. Therefore, the data verification apparatus will not occupy the bandwidth of the public blockchain when verifying and/or querying data.

The above disclosure is only utilized to enumerate some embodiments of the present invention and illustrated technical features thereof, which is not used to limit the scope of the present invention. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for adding data to blockchain, comprising:
a microcontroller, being configured to generate a hash data for an original data of a device according to an algorithm, wherein the hash data is readable by a blockchain; and
a first transmission interface, being electrically connected to the microcontroller, and being configured to transmit the original data and the hash data to a blockchain agent platform and receive a slice of a Merkle tree regarding a node that the hash data is located from the blockchain agent platform, wherein the slice comprises a first evidence data generated based on the hash data.

2. The apparatus for adding data to blockchain of claim 1, further comprising:
a storage, being electrically connected to the microcontroller and being configured to store an identification code of the microcontroller;
wherein the first transmission interface further transmits the identification code and a time stamp corresponding to the original data to a blockchain node of a public blockchain and receives a second evidence data retrieved based on the identification code and the time stamp from a smart contract of the blockchain node,
wherein the microcontroller further retrieves the first evidence data from the slice and determines a result of adding the hash data to the smart contract by comparing the first evidence data with the second evidence data.

3. The apparatus for adding data to blockchain of claim 2, wherein the result is that the hash data has been correctly added to the smart contract when the microcontroller determines that the first evidence data is the same as the second evidence data.

4. The apparatus for adding data to blockchain of claim 2, wherein the result is that the hash data is not correctly added to the smart contract when the microcontroller determines that the first evidence data is different from the second evidence data.

5. The apparatus for adding data to blockchain of claim 1, wherein the microcontroller encrypts the original data and a time stamp corresponding to the original data into the hash data according to the algorithm.

6. The apparatus for adding data to blockchain of claim 5, wherein the algorithm is one of an Advanced Encryption Standard (AES) algorithm, a Secure Hash Algorithm (SHA), an Elliptic Curve Cryptography (ECC) algorithm, and a Base algorithm.

7. The apparatus for adding data to blockchain of claim 1, further comprising:
a second transmission interface, being electrically connected to the microcontroller and configured to receive the original data from the device.

8. A data verification apparatus, comprising:
a storage, being configured to store a hash chain record, wherein the hash chain record comprises a plurality of evidence slices;
a transmission interface, being configured to transmit an identification code of a microcontroller and a time stamp to a blockchain agent platform, receive a first evidence data as well as an original data and a slice of a Merkel tree retrieved based on the identification code and the time stamp from the blockchain agent platform, and receive a second evidence data from a smart contract of a blockchain node of a public blockchain; and
a processor, being electrically connected to the storage and the transmission interface and configured to determine a first verification result by comparing the first evidence data and the second evidence data,
wherein when the first verification result is that the first evidence data is consistent with the second evidence data, the processor further generates a hash data for the original data, generates a third evidence data according to the hash data and the slice, generates a fourth evidence data according to the third evidence data and at least one of the evidence slices, and determines a second verification result by comparing the first evidence data and the fourth evidence data.

9. The data verification apparatus of claim 8, wherein the second verification result is that the original data is correct when the processor determines that the fourth evidence data is the same as the first evidence data.

10. The data verification apparatus of claim 8, wherein the second verification result is that the original data is erroneous when the processor determines that the fourth evidence data is different from the first evidence data.

11. The data verification apparatus of claim 8, wherein the processor encrypts the original data and the time stamp into the hash data by an algorithm.

12. The data verification apparatus of claim 11, wherein the algorithm is one of an AES algorithm, a SHA, an ECC algorithm, and a Base algorithm.

13. A data verification method, being adapted for use in an electronic computing apparatus, the electronic computing apparatus storing a hash chain record, the hash chain record comprising a plurality of evidence slices, the data verification method comprising:
transmitting an identification code of a microcontroller and a time stamp to a blockchain agent platform;
receiving a first evidence data as well as an original data and a slice of a Merkel tree retrieved based on the identification code and the time stamp from the blockchain agent platform;
receiving a second evidence data from a smart contract of a blockchain node of a public blockchain;
determining that the first evidence data is consistent with the second evidence data;
generating a hash data for the original data;
generating a third evidence data according to the hash data and the slice;
generating a fourth evidence data according to the third evidence data and at least one of the evidence slices; and
determining a verification result by comparing the first evidence data with the fourth evidence data.

14. The data verification method of claim 13, wherein the verification result is that the original data is correct when the first evidence data is the same as the fourth evidence data.

15. The data verification method of claim 13, wherein the verification result is that the original data is erroneous when the first evidence data is different from the fourth evidence data.

16. The data verification method of claim 13, wherein the step of generating the hash data encrypts the original data and the time stamp into the hash data by an algorithm.

17. The data verification method of claim 16, wherein the algorithm is one of an AES algorithm, a SHA, an ECC algorithm, and a Base algorithm.
